(19) United States
(12) Patent Application Publication
(10) Pub. No.: US 2001/0025454 A1
(43) Pub. Date: Oct. 4, 2001

(54) Sealing strip, particularly a wipe seal for a motor vehicle sliding window

(75) Inventor: Jean-Loup Cretin, Chalette Sur Loing (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hutchinson, Paris (FR)

(21) Appl. No.: 09/821,304

(22) Filed: Mar. 29, 2001

(30) Foreign Application Priority Data
Mar. 30, 2000 (FR) 0004021

(51) Int. Cl. E06B 7/16

(52) U.S. Cl. 49/441; 49/495.1

(57) ABSTRACT

The invention relates to a sealing strip, particularly a wipe seal for a motor vehicle sliding window and which is intended to be fixed in openings cut in a rabbet of a surround of a door, wherein the fixing means are incorporated into the seal.

### FIELD OF THE INVENTION

The invention relates to a sealing strip, particularly to a wipe seal for a motor vehicle sliding window, such a seal consisting of a section piece produced by extrusion of an elastomeric material such as natural rubber, an EPDM or an thermoplastic elastomer, or made of a thermoplastic such as polypropylene.

### BACKGROUND OF THE INVENTION

A first type of wipe seal is known and comprises at least a part forming a mounting clamp attached to a longitudinal edge ridge of a metal rabbet of the surround of the opening of a door of a motor vehicle and a flexible sealing lip intended to press elastically against one side of a moving window pane.

In general, the visible part of this wipe seal corresponds roughly to the height of its part forming the mounting clamp plus that of the flexible lip.

In order to reduce this visible height of the seal, particularly for the sake of appearance, a second type of wipe seal is known which is mounted in openings cut uniformly in the rabbet. In fact, this rabbet is special in that it is re-entrant into the door box structure. Such a seal no longer has a clamp-forming part, and is mounted by means of clips which have to be attached to the seal before being immobilized in the openings of the rabbet. This mounting technique known as the attached-clip technique is expensive given the cost of the clips, and entails attaching these to the seal accurately because the openings in the rabbet are themselves cut with precise tolerances.

### OBJECTS AND SUMMARY OF THE INVENTION

It is an object of the invention to envisage a novel type of attachment which is capable of alleviating the drawbacks of this second type of wipe seal while at the same time retaining reduced seal visibility.

To this end, the invention proposes a sealing strip, particularly a wipe seal for a motor vehicle sliding window and which is intended to be fixed into openings cut in a rabbet of a surround of a door, which is one wherein the fixing means are incorporated into the seal.

The seal also comprises retaining means to prevent it from being extracted from the rabbet.

In general, the fixing means comprise tabs intended to engage in openings in the rabbet, and a heel so that said tabs and said heel bear respectively on each side of the rabbet.

In the as-extruded state, the seal has two longitudinal branches, one inner and one outer, in which are respectively formed the tabs and the heel which constitute the fixing means.

Advantageously, the heel has cutouts to form the tabs and limit its area of contact with the rabbet.

According to one embodiment, the seal retaining means consist of at least one longitudinal notch formed in the heel of the seal, this notch being intended to bear against the end edge of the rabbet.

According to another embodiment, the seal retaining means consist of a coating and/or of lips made of a material with a high coefficient of friction, the coating and/or the lips being located at the areas of contact between the seal and the rabbet.

According to yet another embodiment, the retaining means consist of additional tabs, the free ends of which fit into the openings of the rabbet.

### BRIEF DESCRIPTION OF THE DRAWING

Other advantages, features and details of the invention will become apparent from the remainder of the description which will follow, with reference to the appended drawings which are given merely by way of example and in which:

FIG. 1 is a sectioned view of a wipe seal of the first type mentioned in the preamble by way of prior art,

FIG. 2 is a sectioned view of a wipe seal of the second type also mentioned in the preamble by way of prior art,

FIG. 3 is a sectioned view of a wipe seal according to a first embodiment of the invention,

FIG. 4 is a partial perspective view of the wipe seal of FIG. 3,

FIG. 5 is a perspective view of a wipe seal according to a variant of the first embodiment,

FIG. 6 is a sectioned view of a wipe seal according to a second embodiment of the invention, and

FIG. 7 is a sectioned view of a wipe seal according to a third embodiment.

### MORE DETAILED DESCRIPTION

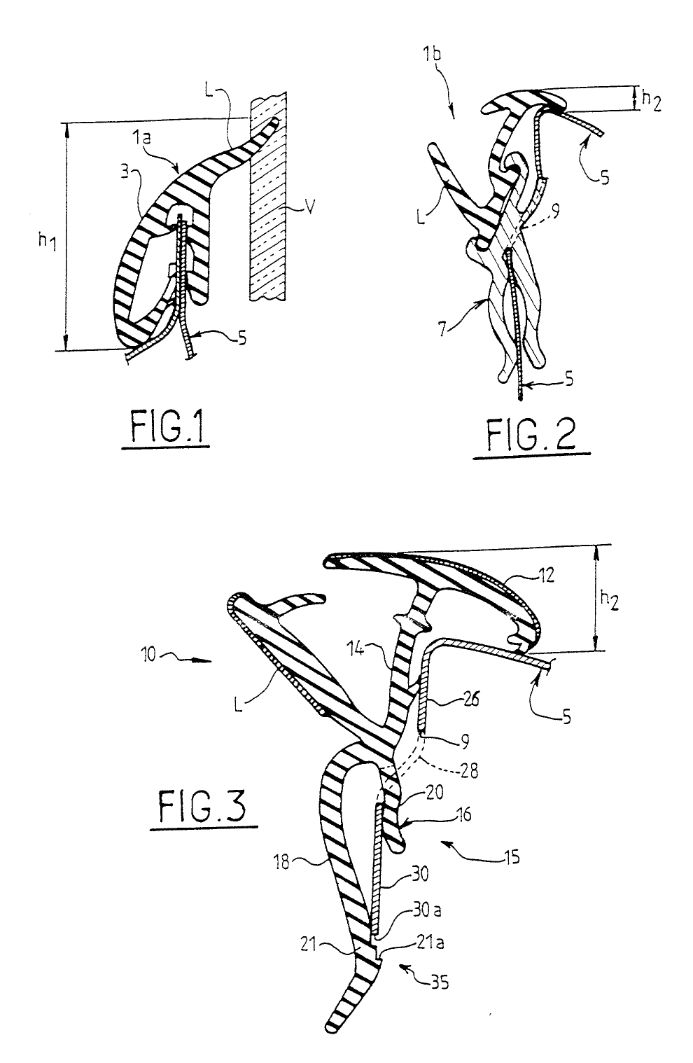

The wipe seals 1a and 1b depicted in FIGS. 1 and 2 illustrate the prior art mentioned in the preamble. The seal 1a of FIG. 1 comprises a part 3 forming a clamp for mounting on the edge ridge of a rabbet 5, while the seal 1b of FIG. 2 is mounted by means of clips 7 attached to the seal 1b, then immobilized in openings 9 cut in the rabbet 5, to reduce the visible part of the seal 1b to a height h2 markedly less than the height hl of the seal 1a. These two seals 1a and 1b have at least one flexible lip L intended to press elastically against one side of a window pane V.

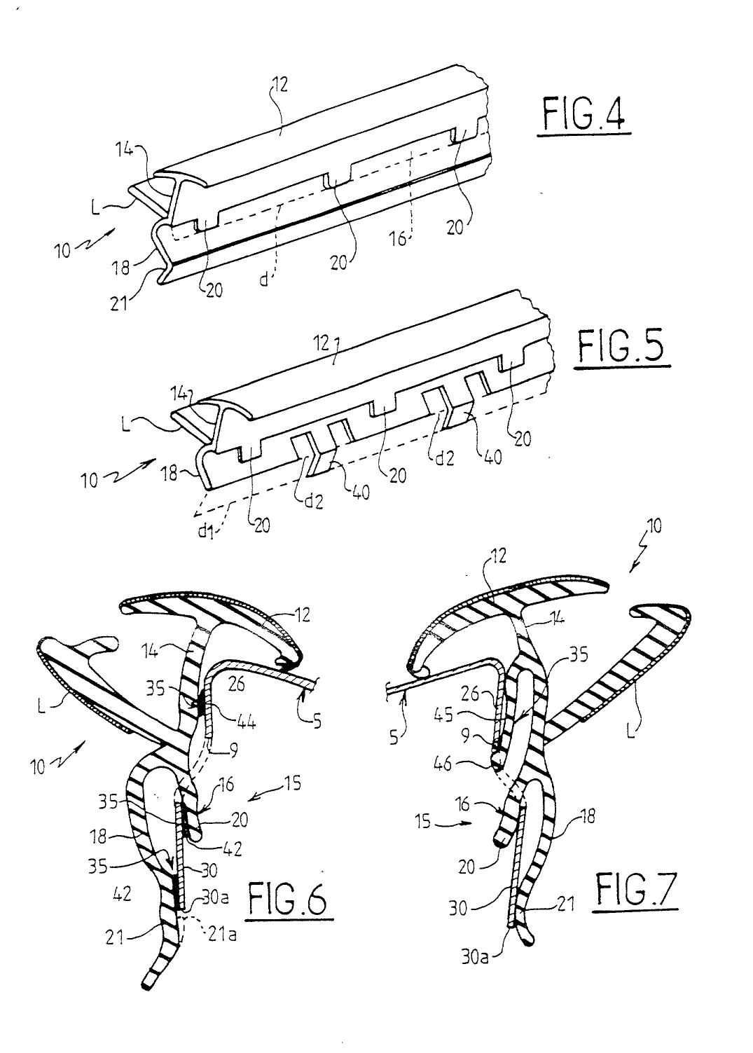

A first embodiment of a wipe seal 10 according to the invention is illustrated in FIGS. 3 and 4, in the knowledge that it is intended to be mounted in openings 9 cut in the rabbet 5, as in the case of the seal 1b of FIG. 2, so that its visible height is small.

The seal 10 is an extruded section which overall can be divided into three parts.

The first part of the seal 10 forms the visible upper part which consists of a transverse tongue 12 intended to come, on one side, into contact with the rabbet 5 and, on the other side, to face the window pane V.

The second part of the seal 10 consists of an intermediate longitudinal wall 14 which extends from the tongue 12 making a T-shape therewith.

The third part of the seal 10 extends the longitudinal wall 14 and forms the fixing means 15 described hereinbelow for anchoring the seal 10 in the rabbet 5.

In the as-extruded state, the third part of the seal 10 has two longitudinal branches, internal 16 and external 18, facing one another and which connect to the intermediate wall 14 forming an inverted U-shape. As is visible in FIG. 4, the internal branch 16 of the seal 10 has cutouts d so as to leave just pegs or tabs 20 for fixing which are intended to fit into the corresponding openings 9 of the rabbet 5.

In general, it is advantageous to limit the area of contact between the external branch 18 of the seal 10 and the rabbet 5 so as to reduce the force needed for fitting the seal 10. For this purpose, the branch 18 is given the shape of an S, for example, so as to form a lower heel 21 which rests against the rabbet 5.

The seal 10 also has at least one sealing lip L which is intended to press elastically against one side of the glass V. The lip L connects to the seal 10 in a region located practically toward the lower end of the intermediate wall 14.

In general, the seal 10 is made by extrusion or coextrusion from a rigid material such as rigid EPDM rubber (with a Shore hardness of between 40 and 70 Shore D) or a thermoplastic such as filled polypropylene, or incorporating a metal reinforcement; and a flexible material (sealing lip L) made of an elastomer such as EPDM rubber or thermoplastic elastomer.

The rabbet 5 penetrates inside the box section of the door 22 forming an elbow 24 so that its end part is bent over inward in an approximately vertical plane. More precisely, the bent-over part forms, in succession, after the elbow 24: an approximately vertical intermediate longitudinal surface 26, an outwardly inclined longitudinal surface 28 and a vertical end longitudinal surface 30 which is thus offset toward the outside with respect to the intermediate surface 26.

The openings 9 in the rabbet 5 are cut at regular intervals along the inclined surface 28, and their number varies according to the length of the seal 10. The openings 9 are thus accessible in the vertical plane of mounting of the seal 10.

In concrete terms, the seal 10 is mounted on the rabbet 5 as follows. The seal 10 is engaged by pressure and pretty much in one piece onto the rabbet 5 by positioning the tabs 20 to face the openings 9 in the rabbet 5.

Once the seal 10 has been fitted (FIG. 3) it will be noted:

that one side of its tongue 12 more or less rests on the rabbet 5,

that its intermediate wall 10 extends parallel to the intermediate vertical surface 26 of the rabbet 5, and

that its heel 21 and the tabs 20 are positioned on either side of the end surface 30 of the rabbet 5, acting like a clamp to anchor the seal 10.

Furthermore, the seal 10 has retaining mans 35 to prevent its accidental extraction.

According to one embodiment illustrated in FIG. 3, these retaining means 35 consist of at least one longitudinal notch 21a formed in the heel 21 and which is located facing the end edge 30a of the rabbet 5.

The presence of several successive notches 21a, forming steps, may be envisioned to make sure that one of them can come into contact with the edge 30a of the rabbet 5 to retain the seal 10.

In this first embodiment, the seal 10 is anchored by the tabs 20 and by the heel 21 which presses continuously along the entire length of the rabbet 5.

In general, the anchoring forces upon the fitting of the seal 10 can be reduced still further by making cutouts in the heel 21 to limit it to tabs 40.

These tabs 40 are obtained, for example, by making first cutouts d1 to remove the heel 21, and second cutouts d2 on each side of the tabs 40. These retaining tabs 40 can be situated facing fixing tabs 20 or offset axially as is illustrated in FIG. 5.

FIG. 6 illustrates a second embodiment of the invention with retaining or anti-extraction means 35 which differ from those of the first embodiment.

The retaining means 35 are means of retention by friction which are provided at the regions of contact between the seal 10 and the rabbet 5.

More specifically, these retaining means 35 are made of a material with a coefficient of friction that is high enough, of the order of 0.7 to 2, to create significant friction. For this purpose, use may be made of an thermoplastic elastomer or a rubber such as EPDM, for example, with a Shore A hardness of the order of 40 to 75.

The friction material is deposited on the seal 10 in the form of a coating 42 at the regions of contact of the tabs 20 and heel 21 with the rabbet 5. It is also possible to envision at least one retaining lip 44 based on said material at the intermediate wall 14 of the seal 10. This lip 44 presses against the intermediate surface 26 of the rabbet 5.

Of course, one or more notches 21a in the heel 21 may be maintained, in order to improve the effectiveness of the retaining means 35.

FIG. 7 illustrates a third embodiment of the invention with retaining means 35 which differ from those illustrated previously.

These retaining means 35 are intended to be positioned at the openings 9 of the rabbet 5. More specifically, the seal 10 has additional tabs 45 which extend roughly parallel to the intermediate longitudinal wall 14 of the seal 10. The end of each tab 45 has an external boss 46 which forms a heel intended to enter an opening 9 of the rabbet 5. These tabs 45 are cut from a branch of the as-extruded seal 10 and are equal in number to the number of openings 9 in the rabbet 5.

Of course, the weatherstrip seal according to the invention is not restricted to weatherstrip seals used in the motor vehicle industry. It can be used as a dirt exclusion seal or as an auxiliary tightness seal, for example.

1. A sealing strip, particularly a wipe seal for a motor vehicle sliding window, this seal incorporating fixing means in the form of tabs intended to fit into openings cut in a seal support rabbet, wherein the fixing means comprise two longitudinal branches in which the tabs are respectively formed and a heel which bear respectively on each side of the rabbet, and wherein the seal also comprises retaining means to prevent it from being extracted from the rabbet.

2. A sealing strip according to claim 1, wherein the seal retaining means consist of at least one longitudinal notch formed in the heel of the seal, this notch being intended to bear against the end edge of the rabbet.

3. A sealing strip according to claim 1, wherein the seal retaining means consist of a coating and/or of lips made of a material with a high coefficient of friction, the coating and/or the lips being located at the areas of contact between the seal and the rabbet.

4. A sealing strip according to claim 1, wherein the retaining means consist of additional tabs, the free ends of which fit into the openings of the rabbet.

5. A sealing strip according to claim 4, wherein the free end of the retaining tabs form a heel.
